(19) United States
(12) Patent Application Publication
(10) Pub. No.: US 2011/0197986 A1
(43) Pub. Date: Aug. 18, 2011

(54) COMPOSITE PIPE FOR HIGH-PRESSURE GAS AND A MANUFACTURING METHOD OF THE SAME

(75) Inventor: Gwan u Im, Gyeonggi-do (KR)

(73) Assignee: Mega Pipe Co., Ltd., Seoul (KR)

(21) Appl. No.: 13/125,923

(22) PCT Filed: Dec. 17, 2008
(86) PCT No.: PCT/KR2008/007480

§ 371 Date: Apr. 25, 2011

(30) Foreign Application Priority Data
Oct. 27, 2008 (KR) 1020080105105

(51) Int. Cl. F16L 9/14; B29C 47/04; B32B 37/02; B32B 37/12; B32B 37/24

(52) U.S. Cl. 138/143; 156/244.13

(57) ABSTRACT

A composite pipe and a manufacturing method for the same are disclosed. The composite pipe for replacing carbon steel pipes for ordinary piping or copper pipes for air-conditioner includes: a first resin layer (1) formed by cross-linking a resin and giving a polar group thereto; a first bonding layer (2) for inducing bonding by sharing radical groups of the first resin layer and a metal layer; the metal layer (3); a second bonding layer (4) for inducing bonding by sharing radical groups of the metal layer; and a second resin layer (5) formed by cross-linking a resin and giving a polar group thereto, thereby integrating the layers chemically and physically.

### TECHNICAL FIELD

The present invention relates to a plastic and metal composite pipe to reply e a copper pipe made of high-priced copper and used for carbon steel pipes for ordinary piping and pressure service or air-conditioner copper pipes.

### BACKGROUND ART

High-priced copper pipes have been used for air-oonditioners because of the characteristics of high pressure resistance, durability heat resistance, anti-chemical charcteristics and bending radius properties of the pipes made of copper.

However, in addition to the shortcomings of the high price, the copper pipe has problems in that a high contraction and expansion rate at a connector part degrades gas preservation characteristics, and when the copper pipe is used for a long period of time, scale is formed thereon, so the copper pipe needs to be replaced at a certain time point.

In case of an alternative pipe made of a mixed material of magnesium and aluminum which has been proposed to replace the conventional, copper pipe, if the alternative pipe exceeds a pressure condition of 5˜10 kgf/cm², it fails to tolerate the pressure, and when the pipe has a flaw, it is not required to be entirely changed but only a corresponding portion (flawed portion) is changed through welding in order to reduce costs. In that case, scale is generated due to a transition difference between two heterogeneous metals, Furthermore metal have not so strong for anti-chemical and the welded portion interferes with fluid flow. In addition, when an air-conditioner is made of the pipe, it is difficult to perform welding on the spot and only a 10˜20% cost reduction is expected.

There has been no case of using a plastic material in the sector of air-conditioners, and in case of pipes developed in the similar form as hot water pipes or pressure pipes, different from the air-conditioner sector, an adhesive is used to bond layers constituting a pipe, causing an interlayer separation due to expansion and contraction according to a temperature change. That is, such a pipe is considerably susceptible to the temperature change.

### DISCLOSURE OF INVENTION

### Technical Problem

The present invention solves the above problems, and provides a composite pipe for replacing carbon steel pipes for ordinary piping and pressure service or air-conditioner copper pipes, which includes a resin layer and a metal layer by chemical reaction between a resin layer and a metal layer. Specifically, a first resin layer, a first bonding layer, a metal layer, a second bonding layer, and a second resin layer, which are made of a plastic material not used yet for the sector of air conditioners, whose physical properties are integrated by inducing chemical bonding through a reaction of bonding layers without using an adhesive, to thereby increase an internal bonding force (interlayer radical bonding force) by chemical bonding by more than 40 kgf/cm² and increase an ultimate tensile strength pressure degree with respect to pressure from 10 kgf/cm² to 250 kgf/cm², without causing an interlayer separation phenomenon in spite of contraction and expansion according to a chemical or physical change, in particular, according to a temperature change, and maintain the chemical bonding of the respective layers for more than 50 years (P-100 condition of more than 100 years based on a “BODYCOTE ” report in Sweden) in any troublesome conditioners without causing the layers to be separated even at ±300° C.

The present invention further provides a composite pipe for replacing carbon steel pipes for ordinary piping and pressure service or air-conditioner copper pipes, which has a fast internal fled speed compared with the conventional high-priced copper pipe, solves the problem of scale generated within the copper pipe, and has a heat conductivity that does not require lagging materials (332 Kcal/mhr° C., copper conductivity of one-thousandth of the conventional copper conductivity, 0.37 Kcal/mhr° C. of the alternative pipe, so electricity rates and costs otherwise incurred for applying lagging materials can be saved), flexibility, durability, and ultimate tensile strength, and yield tensile strength in conformity with the international standards.

The present invention further provides a process for manufacturing a composite pipe for replacing carbon steel pipes for ordinary piping and pressure service or air-conditioner copper pipes.

### Technical Solution

In accordance with an exemplary embodiment of the present invention, the present invention provides a composite pipe for replacing carbon steel pipes for ordinary piping and pressure service or air-conditioner copper pipes. The composite pipe includes: a first resin layer positioned at the innermost portion of the pipe and formed by cross-linking a resin and giving a polar group thereto; a first bonding layer positioned between the first resin layer and a metal layer and bonding the first resin layer and the metal layer by commonly having (sharing) a radical group of the first resin layer and that of the metal layer; the metal layer positioned between the first bonding layer and a second bonding layer and bonding the first and second bonding layers by sharing metal radicals; the second bonding layer positioned between the metal layer and a second resin layer and bonding the metal layer and the second resin layer by sharing radical groups of metal layer and the second resin layer; and a second resin layer positioned at the outermost portion of the pipe and formed by cross-linking a resin and giving a polar group thereto. The bonding strength of the bonding layers of the composite pipe is stronger than the materials themselves, so the bonding layers cannot be separated until they reach a maximum breakdown value and are broken. The layers of the composite pipe are physically and chemically integrated so as to continuously have the same contractile/expansive force as a single material.

In a process for manufacturing the composite pipe for replacing the air-conditioner copper pipe, a resin is injected into a hopper of a main extruding machine and then introduced into a cylinder, wherein the point at which the resin is introduced and a point from which the resin is extruded have different temperatures, and the temperature is gradually increased from the resin introduction point to the resin extrusion point. The resin in the cylinder is moved by rotating a screw.

The moved resin is extruded by a nozzle and is moved, as a first resin layer, to a mold, and the first bonding layer, the metal layer, the second bonding layer, and the second resin layer are sequentially annularly joined to the outer circumference of the first resin layer to extrude the composite pipe for replacing carbon steel pipes for ordinary piping and pressure service or air-conditioner copper pipes. The extruded composite pipe is processed in a cooling tub, and then wound, thus completing the manufacturing process.

The metal layer is a thin metal plate film, which is not separately subject to the extruding process but annularly joined to the outer circumference of the first bonding layer.

The rust bonding layer, the second bonding layer, and the second resin layer are extruded under the same conditions as those of the first resin layer.

In the following description, the technical configuration of the present invention is described in detail.

The First Resin Layer

The first resin layer is positioned at the innermost portion of the composite pipe.

Because it is directly in contact with a gas, a suitable resin should be selected in consideration of gas interception characteristics.

After a pressure piping resin is cross-linked to increase heat resistance, the first resin layer is formed to have polarity in a non-polar state to facilitate bonding with the first bonding layer which will be described later. As for a molecular structure, a polymer bonding structure in a saturated state, which does not react even with a strong acid, is maintained to prevent any chemical reaction with respect to a refrigerant.

Regarding resin polarization, for example, an olefin based resin is commonly used as an extrusion/injection molding product because of its good molding characteristics, heat resistance, and mechanical characteristics. However, it does not have polarized molecules, thus causing it to have a degraded bonding force with metals. Thus, the olefin based resin is polarized to have a high bonding force with a metal or polar resin as well as good compatibility therewith.

The resin may include two or more selected from among styrene isoprene styrene (SIS) resin, styrene butadiene styrene (SBS) resin, styrene ethylene butyl styrene (SEBS) resin, styrene ethylene propylene styrene (SEPS) resin, an alpha methyl styrene, vinyl toluene, 4-chloro styrene, 3,4-dichloro styrene, polyethylene, polypropylene, polybutene, polymethypentene, EPDM ternary polymer, ethylene/propylene copolymer, ethylene/butane copolymer, ethylene/vinyl acetate copolymer, ethylene/ethyl acrylate copolymer, and olefin based rubber.

The polarization of the olefin based resin proposed as the substantial example is performed through the following process.

Cleavage of Peroxides

R—O—O—R′→R—O·+R′—O· (1)

Peroxide, which is an oxide having an O group with a molecular valence value of −2, includes dialkyl peroxide R—O—O—R— and asyl peroxide RCO—O—O—OCR.

Peroxide is used as a radical initiator, and molecular binding of two oxygen atoms of the peroxide (R—O—O—R) is cut to make two electrons for O—O binding such as R—O · and R′—O· separated into two parts to form a radical (Reaction 1).

Hydrogen Abstraction

R—O·+H—PO→R—O—H+PO· (2)

R—O· separated from the peroxide is bound with ‘H’ of polyolefin (PO) to separate hydrogen from polyolefin, causing polyolefin to have a polarity of PO·.

A polar covalent bond in relation to the modified polyolefin having the polarity will now be described in brief. A chemical bond of two atoms accompanies energy reduction in a reaction system like in Equation (3) shown below:

A+B→AB+energy (3)

‘AB’ is a single bond of the two atoms ‘A’ and ‘B’ which means that the two atoms share a pair of electrons. If ‘A’ and ‘B’ are the same elements, shared electrons would be equally distributed, and this bond is called a non-polar bond. If ‘A’ and ‘B’ are different elements, shared electrons of the two atoms would be inclined to a side, among the two atoms, having stronger electron attraction, making the molecular structure asymmetrical. This bond is called a polar covalent bond.

First Bonding Layer

The first bonding layer is positioned between the first resin layer and the metal layer to bind the first resin layer and the metal layer in such a way that a radical group of the first resin layer and that of the metal layer are shared. The first bonding layer is activated when the pipe is manufactured, and stabilized while being cooled.

Thus, in order to maximize bonding when the first bonding layer and the metal layer are reacted, the first coupling layer is acid-processed as in Equation (4) shown below to make the radicals activated when the pipe is manufactured.

PO·+A-H→PO-A+H· (4)

The monomer of A-H is modified by using a resin of an acid group with a large activation potential difference. The acid group has a carboxyl group such as nitric acid (CH₃COOH).

Metal Layer

The metal layer is positioned between the first and second bonding layers, and a type of a metal plate film selected from among Fe, Al, Cu, Mg, Zn, and Ti is used as the metal layer.

Second Bonding Layer

The second bonding layer has the same characteristics as the first bonding layer, which shares groups of the metal layer and the second resin layer.

Second Resin Layer

The second resin layer is an external resin pressure layer. Its radial group is coated to change the polarity thereof. Relevant components may be added in consideration of blocking ultraviolet rays and providing flame resistance.

Components that may be used to block ultraviolet rays include benzophenone derivatives such as 2,2-dihydroxy-4-methoxybenzophenone, 2-hydroxy-4-methoxybenzophenone, 2-hydroxy-4-oxtosy benzophenone, and as a flame retardant for providing the flame resistance, one or more selected from among a brominated flame retardant, a halogen group flame retardant of a chlorinated flame retardant, and a phosphorous retardant containing red phosphorus, an ammonium phosphate group, aliphatic phosphate, an aromatic phosphate, and alkyl phosphate containing some halogen elements.

The composite pipe for replacing carbon steel pipes for ordinary piping and pressure service or air-conditioner copper pipes may be variably applicable in terms of its material characteristics. For example, the composite pipe may be used for semi-conductor trays, bullet-proof vests, bullet-proof helmets and other impact absorbent materials, may be used as a substitute of nonferrous metal collar steel pipes or a substitute of air-conditioner copper pipes, or may be used for cleaner suction pipe hoses of magnesium/aluminum composite pipes, and high-pressure gas pipes for other industrial/mechanical/building materials.

The composite pipe for replacing carbon steel pipes for ordinary piping and pressure service or air-conditioner copper pipes is manufactured by sequentially and annularly combining the first resin layer, the first bonding layer, the metal layer, the second bonding layer, and the second resin layer.

All the layers, excluding the metal layer, undergo the extrusion process. The first resin layer is first extruded, and subsequently, the first bonding layer, the second bonding layer, and the second resin layer are sequentially extruded through each extruding machine and then joined annularly to the outer circumference of the first resin layer.

The extruding machines and the extruding conditions of the first resin layer, the first bonding layer, the second bonding layer, and the second resin layer are the same, and details of which will now be described by taking the first resin layer as an example.

First, the resin is input into a hopper maintained at 70˜80° C. and a dry state is maintained for two to three hours.

The reason for maintaining the dry state at 70˜80° C. in the hopper is to prevent the occurrence of a problem that the activated radical of polymer chains is bonded with moisture to degrade the bonding force with the first bonding layer.

In manufacturing plastic according to the related art, although the content of moisture is about 1%, it does not much affect a reaction, but in the present invention, cohesive power between layers/materials is critical, so if the content of moisture is about 1%, activated radicals of polymer chains in organic ions would be bonded with moisture when metal and the organic ions are bonded on the surface, degrading the cohesive power between layers/materials. Thus, a moisture content of less than 0.1%, a negligible amount to interfere with the bonding force, is maintained.

An excess time period of the dry state in the range of more than three hours may cause a problem with respect to operability, so it is preferred to maintain the dry state within the range of two to three hours according to a manufacturing speed.

Next, the resin is inputted through the hopper into the cylinder of which the resin-inputted portion has a temperature of about 150˜160° C. and the portion where the resin is extruded by a nozzle has a temperature of about 210˜220° C., the temperature of the cylinder being controlled to be gradually increased at the section along which the resin is moved, and then, the resin is moved to the nozzle by using rotation of a screw within the cylinder.

Subsequently, the resin is extruded through the nozzle and moved to an inner aperture mold, and then, the first bonding layer, the metal layer, the second bonding layer, and the second resin layer are sequentially and annularly joined to manufacture the composite pipe for replacing carbon steel pipes for ordinary piping and pressure service or air-conditioner copper pipes, which is then processed in a cooling tub and wound to thus complete the manufacturing process.

The speed of the screw within the cylinder is maintained at 40˜70 rpm in consideration of the viscosity of the resin, the temperature of the nozzle is maintained at 200˜210° C., and the temperature of the mold is maintained at 30˜60° C.

### Advantageous Effects

As described above, the composite pipe for replacing carbon steel pipes for ordinary piping and pressure service or air-conditioner copper pipes can replace a high-priced copper pipe by using plastic which has not been used in the sector of air-conditioners. Without using an adhesive, the chemical and physical properties of the first resin layer, the first bonding layer, the metal layer, the second bonding layer, and the second resin layer of the composite pipe are integrated through reactions therebetween, whereby an internal bonding force (interlayer radical bonding force) according to the chemical bonding can be increased by more than 40 kgf/cm², the ultimate tensile strength pressure degree with respect to pressure can be increased from 10 kgf/cm² to 250 kgf/cm², and because the layers can tolerate such conditions, even under temperature conditions of ±300° C., the chemical bonding between the respective layers can be advantageously maintained for more than 50 years in any problematic conditions.

In addition, compared with the conventional high-priced copper pipe, a fast internal fluid speed can be obtained, the problem of a scale generated within the copper pipe can be resolved, and lagging materials are not required.

Also, the pressure, ductility, durability, and ultimate tensile strength, and yield tensile strength are in conformity with international standards, and because an adhesive is not in used, the composite pipe according to the present invention is environment-friendly.

### BRIEF DESCRIPTION OF DRAWINGS

The features and advantages of the present invention will become more apparent from the following detailed description in conjunction with the accompanying drawings, in which:

FIG. 1 is a cross-sectional view showing a layer structure of a composite pipe according to an embodiment of the present invention;

FIG. 2 is a schematic view of an apparatus for manufacturing the composite pipe according to an embodiment of the present invention; and

FIG. 3 is a schematic view of an extruding machine of the composite pipe manufacturing apparatus according to an embodiment of the present invention.

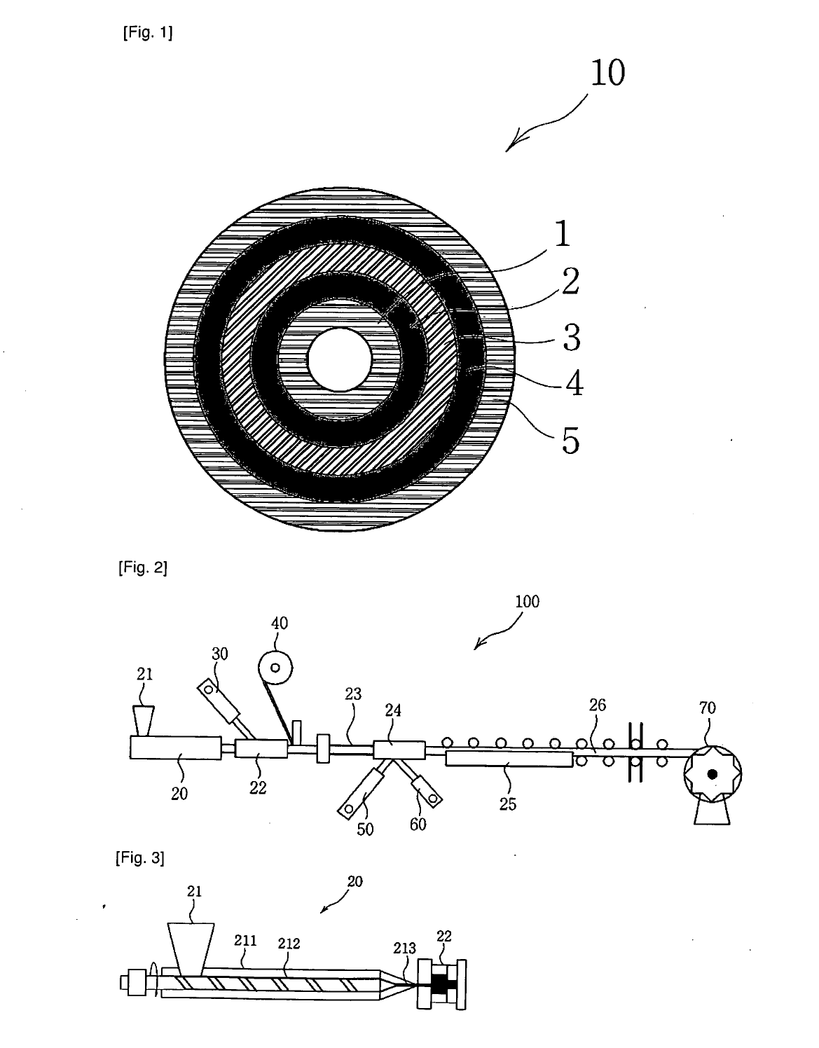

### BEST MODE FOR CARRYING OUT THE INVENTION

Hereinafter, exemplary embodiments of the present invention are described in detail with reference to the accompanying drawings. The technical configuration of a composite pipe for replacing carbon steel pipes for ordinary piping and pressure service or air-conditioner copper pipes according to an exemplary embodiment of the present invention will now be described.

Regarding a layer structure of the composite pipe 10 for replacing carbon steel pipes for ordinary piping and pressure service or air-conditioner copper pipes, the composite pipe 10 includes a first resin layer 1, a first bonding layer 2, a metal layer 3, a second bonding layer 4, and a second resin layer 5 which are sequentially formed in this order starting from the inner side of the composite pipe 10.

As for the conventional pipe proposed to replace copper pipes, an adhesive is used to bond the layers to form the pipe of the multi-layered structure. The use of the adhesive cause's interlayer separation as the pipe is repeatedly contracted or expanded according to temperature changes. The present invention solves the problem of the conventional pipe by forming the first and second bonding layers 2 and 4. That is, the first bonding layer 2 is chemically bonded with the first resin layer 1 and the metal layer 3, and the second bonding layer 4 is chemically bonded with the metal layer 3 and the second resin layer 5, thereby making the composite pipe 10 behave integrally.

The composite pipe 10 for replacing carbon steel pipes for ordinary piping and pressure service or air-conditioner copper pipes is manufactured by extruding the first resin layer 1 and then sequentially joining the first bonding layer 2, the metal layer 3, the second bonding layer 4, and the second resin layer 5 annularly to the outer circumference of the first resin layer 1, for which an apparatus for manufacturing a composite pipe for replacing carbon steel pipes for ordinary piping and pressure service or air-conditioner copper pipes as shown in FIG. 2 is used.

FIG. 3 shows the configuration of a main extruding machine 20, which is applied in the same manner to a first resin layer extruding machine 30, a first bonding layer extruding machine 50, and a second resin layer extruding machine 60.

Extruding conditions and processes of the first resin layer 1, the first bonding layer 2, the second bonding layer 4, and the second resin layer 5 are the same. Regarding the extruding process of the first resin layer 1, a resin is input into a hopper 21 of the main extruding machine 20 as shown in FIG. 3, maintained in a dry state at 60˜70° C. for two to three hours.

The temperature at a portion from which the resin is input is maintained at 150˜160° C. and the temperature at a portion from which the resin is to be extruded by a nozzle is maintained at 210˜220° C., so that the interior of the cylinder 211 has a temperature that goes up gradually by sections and receive the resin. The input resin is moved toward the nozzle 213 according to the rotation of a screw 212 mounted within the cylinder 211.

The resin is extruded through the nozzle 213 and moved to an inner aperture mold 22.

The first bonding layer 2 extruded through the first bonding layer extruding machine 30 and the metal layer 3 of a metal plate film 40 are sequentially and annularly joined and fixed to a circumference of the first resin layer 1, and are, then, heated at a heating zone 23 to manufacture an inner aperture.

Thereafter, the second bonding layer 4 extruded through the second bonding layer extruding machine 50 and the second resin layer 5 extruded through the second resin layer extruding machine 60 are sequentially and annularly joined to the circumference of the inner aperture through an outer aperture mold 24 to manufacture the composite pipe for replacing carbon steel pipes for ordinary piping and pressure service or air-conditioner copper pipes. And then, the composite pipe is subjected to a cooling process in a cooling tub 25, and wound by using a winder 70, to complete the manufacturing process.

Physical characteristics of the composite pipe 10 for replacing carbon steel pipes for ordinary piping and pressure service or air-conditioner copper pipes configured as described above will now be explained.

Experimental Example 1

Regarding the composite pipe for replacing carbon steel pipes for ordinary piping and pressure service or air-conditioner copper pipes, the pressure, durability, general physical properties and characteristics required for the copper pipe used for the conventional air-conditioner piping were compared and analyzed by employing the ASTM 1335 method, an international testing method high pressure gas tubes. As for a material co-extruded by applying high functionality engineering plastic, which was comprised of a mixture of metal and plastic, which initially had differentiated values with respect to pressure tolerance, after chemical radicals of each layer were bonded, combined to provide an overall integrated value thereby amplifying a resistance value with respect to an ultimate tensile strength pressure of each plastic layer, thus providing a high pressure gas tube that can tolerate a tensile strength pressure equal to that of an existing air-conditioner copper pipe. Thus, a unit cost can be reduced by 50% or more than that of current costs.

First, in order to calculate the thickness of desired corresponding physical properties of the composite pipe for replacing carbon steel pipes for ordinary piping and pressure service or air-conditioner copper pipes, and the pressure of each layer, a Hoop stress configuration is applied.

<Application of Hoop Stress Configuration>

The equation for Hoop stress calculation is used to measure degradation of ultimate tensile strength pressure of petrochemical polymer of a pipe made of a petrochemical polymer over time. The equation calculates fatigue of bonding polymers over time at a uniform temperature under uniform pressure in order to measure durability of the plastic pipe, for which the following matters have been verified.

Under a certain temperature, the same plastic pipes of a certain thickness has the same ultimate tensile strength and yield tensile strength (inherent numbers of materials), and the ultimate tensile strength and yield tensile strength in the pipe are generally determined by the materials used.

Therefore, in a state that the ultimate tensile strength pressure (Mpa) of each pipe is accurately decided, the thickness of corresponding physical properties of a desired pipe and the pressure of each layer can be calculated by modifying the equation of Hoop.

$$P = \frac{2 \cdot σ \cdot Emin}{Dav \cdot Emin \cdot I} \cdot 10 [ Bars ] \qquad [ Equation 1 ]$$

Wherein denotes the circumferential stress (Mpa), Day denotes the average external diameter of the pipe (mm), Emin denotes the minimum wall thickness of the pipe (mm), and P denotes the internal water pressure in the pipe (bars).

Because time is not considered for a certain temperature and the ultimate tensile strength pressure in Equation 1, Equation 1 may be modified into Equation 2 shown below:

$$\begin{matrix}σ = \frac{P \cdot D}{2 t} t = \frac{P \cdot D}{2 σ} & [ Equation 2 ] \\ P = \frac{2 t \cdot SIGMA}{D} & [ Equation 3 ]\end{matrix}$$

<Selection of Metal and Calculation of Thickness>

The equation of Hoop allows for the replacement of a copper pipe of a pipe of an air-conditioner, made of petrochemical polymer. In order to provide a pipe with the same bending radius as that of copper, the following correlation can be determined by experimental values for a bending radius of aluminum (Al) and the developed resin.

R_{AL}·(t−0.15)+R_{PL}·(2t)=R_{CU}·t [Equation 4]

wherein R_{AL} is a bending radius of a pure aluminum material without an alloy, R_{PL} is a bending radius of the developed resin of the present invention, R_{CU} is a bending radius of a pipe of an air-conditioner and a general copper material, and ‘t’ is the thickness of an original copper pipe (average tolerance=t±0.15)

Table 1 shows selected aluminum materials that satisfy such conditions.

TABLE 1

| | Mpa | | kgf/cm² | |
|---|---|---|---|---|
| | Tensile | Yield | Tensile | Yield |
| Material | Strength | Strength | Strength | Strength |
| Al material* | Ultimate | Yield | Ultimate | Yield |
| Aluminum 1050-O | 76 | 28 | 760 | 280 |
| Aluminum 1060-O | 70 | 30 | 700 | 300 |
| Aluminum 1100-O | 95 | 35 | 950 | 350 |
| Aluminum 1145-O | 75 | 35 | 750 | 350 |
| Aluminum 1350-O | 85 | 30 | 850 | 300 |
| Aluminum 2014-O | 185 | 95 | 1850 | 950 |
| Aluminum 2017-O | 180 | 70 | 1800 | 700 |
| Aluminum 2024-O | 185 | 75 | 1850 | 750 |
| | | Material | | |
| | | Property Data | | |

(*The aluminum materials were selected from a list on a website, http://www.matweb.com/Search/MaterialGroupSearch.aspx?GroupID=178)

There are more than hundreds or thousands of types of aluminum such as numerous alloy systems, pure systems, and the like, and three variables should be considered in selecting aluminum therefrom.

First, the difference of yield values should be small while maintaining the ultimate tensile strength pressure.

Second, the ultimate tensile strength pressure should exceed a certain level of 700˜2,000 kgf/cm² under the conditions that ductility is maintained. By maintaining the level, the composite pipe can have the same flexibility as that of copper in replacing the air-conditioning pipe.

Third, pure aluminum should be selected. ‘O’ attached to the Al materials in Table 1 denotes pure aluminum for which there is no interference of bonding radicals by different heterogeneous metals. As the purity is high, the phenomenon that the grade of force is uniformly distributed is maintained to its maximum level (there is a certain grade of force in a molecular matrix of a counterpart bonding layer: a phenomenon that abrupt pressure or stress is received due to non-uniformity of force). Namely, it can allow a layer to be bonded with another bonding layer homogeneously.

<Application of the Relationship Between the Interlayer Thickness and Pressure of the Pipe>

A proper thickness of each layer which is close to the required pressure of the copper pipe can be decided by applying the ultimate tensile strength pressure of the selected material Al 1100-0 based on Equation (3) (Table 2).

TABLE 2

| Outer | | | | | | | | |
|---|---|---|---|---|---|---|---|---|
| Dia. of | | Outer Dia. of | Inner | | Metal | | | Sum of |
| Cu Pipe | | substitute pipe | Dia. | Alumium | resin | inside | out | thicknesses |
| 6.35 | 1 | 9.35 | 4.95 | 0.5 | 0.2 | 1 | 0.5 | 2.2 |
| 9.52 | 2 | 12.92 | 8.12 | 0.5 | 0.2 | 1 | 0.7 | 2.4 |
| 12.7 | 3 | 16.6 | 11.1 | 0.55 | 0.2 | 1 | 1 | 2.75 |
| 15.88 | 4 | 20.88 | 14.28 | 0.6 | 0.2 | 1.5 | 1 | 3.3 |
| 19.05 | 5 | 24.05 | 17.45 | 0.6 | 0.2 | 1.5 | 1 | 3.3 |

The required pressure of an air-conditioner is five times a room atmospheric pressure, and because required pressure of five standards of existing air-conditioners have been determined, pipe thickness can be calculated by using Equation (3). The average external diameter of the pipe (mm), D, to which the pressure of each required standards is applied is determined. Also, an ultimate tensile strength pressure, an inherent value of a material made of selected Al, is determined (SIGMA value). Thereafter, a pipe of a desired pressure can be produced by using a SIGMA value of each material with respect to the thickness of each layer which is close to an approximate value.

The ultimate tensile strength pressure of each layer of the air-conditioner pipe by employing the selected Al 1100-0 was calculated by using Equation (4) as shown in Table 3

TABLE 3

| | | | | | Outside | | Metal |
|---|---|---|---|---|---|---|---|
| World | | | Inside | | resin | | resin |
| standards of | Al layer | | resin layer | | layer | | layer |
| air-conditioners | UTS | YTS | UTS | YTS | UTS | YTS | UTS |
| 1 | 101.604278 | 37.43315508 | 23.52941176 | | 22.22222222 | | 3.232323232 |
| 2 | 73.5294118 | 27.08978328 | 17.027863378 | | 18.96551724 | | 1.97044335 |
| 3 | 62.9518072 | 23.19277108 | 13.25301205 | | 19.81981982 | | 1.441441441 |
| 4 | 54.5977011 | 20.11494253 | 15.8045977 | | 15.40616246 | | 1.120448179 |
| 5 | 47.4012474 | 17.46361746 | 13.7214372 | | 12.60744986 | | 0.916905444 |

(UTS: Ulitimate Tensile Strength; YTS: Yield Tensile Strength)

<Application Range of Thickness of Pipe>

When a metal ion resin and a metal layer are determined to be aluminum, a thickness range of a substitute pressure tube maintaining the same physical properties as those of the air-conditioner copper pipe is calculated as shown in Table 4.

TABLE 4

| Outer | | Outer | | | | Inside | Outside | |
|---|---|---|---|---|---|---|---|---|
| diameter | Size | diameter of | Inner | | Metal | conversion | conversion | |
| of copper | of | substitute | diameter | | resin | resin | resin | Sum of |
| pipe | air-conditioner | pipe (mm) | (mm) | Al (mm) | (mm) | (mm) | (mm) | thicknesses |
| 6.35 | 1 | 9.35 ± 1.4 | 4.95 | 0.5 ± 0.15 | 0.2 ± 0.1 | 1 ± 0.3 | 0.5 ± 0.15 | 2.2 ± 0.7 |
| 9.52 | 2 | 12.92 ± 1.4 | 8.12 | 0.5 ± 0.15 | 0.2 ± 0.1 | 1 ± 0.3 | 0.7 ± 0.15 | 2.4 ± 0.7 |
| 12.7 | 3 | 16.6 ± 1.7 | 11.1 | 0.55 ± 0.15 | 0.2 ± 0.1 | 1 ± 0.3 | 1 ± 0.3 | 2.75 ± 0.85 |
| 15.88 | 4 | 20.88 ± 1.7 | 14.28 | 0.6 ± 0.15 | 0.2 ± 0.1 | 1.5 ± 0.3 | 1 ± 0.3 | 3.3 ± 0.85 |
| 19.05 | 5 | 24.05 ± 1.7 | 17.45 | 0.6 ± 0.15 | 0.2 ± 0.1 | 1.5 ± 0.3 | 1 ± 0.3 | 3.3 ± 0.85 |

<Interlayer Bonding Force of Pipe Structure>

When the bonding force between the resin layer and the metal layer exceeds 25 kgf/cm, the interlayer bonding force becomes stronger than the bonding force of the resin layer. Namely, even if the resin layer is broken, the bonded portion is not detached. In other words, each layer has the same shrinkage factor as that of the same material for a change in internal and surrounding temperatures.

In addition, the overall yield rate is the same as an arithmetic average of each layer, resulting in that the overall bonding parts always have a higher heat resistance than that of the innermost cross-linked resin (it is maintained without being detached in spite of a temperature change of ±300° C. (Table 5).

TABLE 5
Table

| | Test Condition ASTM | |
|---|---|---|
| Nominal Pipe Size | F1335 - 9.1.5 | Test Result |
| All size | 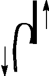 | >40 kgf/cm |
| | Tensile Speed: 25 mm/min | |

<Calculation of Overall Ultimate Tensile Strength Pressure Using Interlayer Bonding Force of Pipe Structure>

If the interlayer bonding force is smaller than 25 kgf/cm, each layer is separated according to a change in the shrinkage factor caused by a sharp temperature difference. In this case, only the highest ultimate tensile strength pressure constituting the layers is maintained as the sum of the overall pressures.

P (Ultimate Tensile Strength)=MAX [P₁, P₁, P₁, P₁, . . . ]

However, if the interlayer bonding force exceeds 25 kgf/cm, the ultimate tensile strength pressure of the overall pipe is the same as the sum of integrated values of the respective layers.

P(Ultimate Tensile Strength)=(P1*K1+K2)+(P2*K2+K3)+(P3*K3+K4)+(P4*K4+K5)+. . .

[symbol]

The ultimate tensile strength and yield tensile strength values of the substitute pipe of the present invention which has been manufactured, experimented, tested and mass-produced based on the above equations are as shown in Table 6.

TABLE 6

| World | | Inside resin | Outside resin | Metal resin | Sum of ultimate |
|---|---|---|---|---|---|
| standards of | Al layer | layer | layer | layer | tensile strength |
| air-conditioners | Ultimate tensile strength | | | | KGF/CM2 |
| 1 | 101.604278 | 23.52941176 | 22.22222222 | 3.232323232 | 150.5882353 |
| 2 | 73.5294118 | 17.02786378 | 18.96551724 | 1.97044335 | 111.4932361 |
| 3 | 62.9518072 | 13.25301205 | 19.81981982 | 1.441441441 | 97.46608054 |
| 4 | 54.5977011 | 15.8045977 | 15.40616246 | 1.120448179 | 86.92890949 |
| 5 | 47.4012474 | 13.72141372 | 12.60744986 | 0.916905444 | 74.64701642 |

### Comparative Example 1

First, the size and pressure of the conventional copper pipe are as shown in Table 7.

TABLE 7

| | Outer | Inner | Room atmospheric | SPEC required |
|---|---|---|---|---|
| | diam- | diam- | pressure of | pressure (room |
| | eter | eter | air-conditioner | atmospheric |
| | (mm) | (mm) | (Equilibrium)* | pressure × 5)** |
| Comparative | 6.35 | 4.95 | 15 kgf/cm² | 75 kgf/cm² |
| example 1 | | | | |
| Comparative | 9.52 | 7.92 | 15 kgf/cm² | 75 kgf/cm² |
| example 2 | | | | |
| Comparative | 12.7 | 11.1 | 8 kgf/cm² | 40 kgf/cm² |
| example 3 | | | | |
| Comparative | 15.88 | 13.88 | 12 kgf/cm² | 60 kgf/cm² |
| example 4 | | | | |
| Comparative | 19.05 | 16.65 | 10 kgf/cm² | 50 kgf/cm² |
| example 5 | | | | |

(*denotes ultimate tensile strength.
**denotes ultimate tensile strength required for product application, which is test conditions recommended by international standards and five times the room atmospheric pressure)

Measurement values of the ultimate tensile strength and yield tensile strength of the substitute pipe according to the present invention compared with the conventional copper pipe of Table 7 are as shown in Table 8.

TABLE 8

| | Outer | Inner | Ultimate | Yield |
|---|---|---|---|---|
| | diameter | diameter | tensile | tensile |
| | (mm) | (mm) | strength | strength* |
| Embodiment 1 | 9.35 | 4.95 | 255 kgf/cm² | 157 kgf/cm² |
| Embodiment 2 | 12.72 | 7.92 | 161 kgf/cm² | 100 kgf/cm² |
| Embodiment 3 | 16.6 | 11.1 | 165 kgf/cm² | 115 kgf/cm² |
| Embodiment 4 | 20.48 | 13.88 | 155 kgf/cm² | 105 kgf/cm² |
| Embodiment 5 | 23.25 | 16.65 | 145 kgf/cm² | 110 kgf/cm² |

(*denotes yield tensile strength refers to a point from which deformation starts without returning to an original form after a pressure is applied thereto)

The ultimate tensile strength and the yield tensile strength values are values measured according to a production unit cost, not a final max value, and when the ultimate tensile strength and the yield tensile strength values are adjusted for the finally selected layer structure of a product and an optimum mass-production material, the pressure of the ultimate tensile strength may be increased by a maximum of 50% and the yield tensile strength may be increased by a maximum of 65%.

Comparison of Physical Properties

Comparison results with respect to durability and chemical-resistance, pressure-resistance, heat-resistance, and fluid liquidity required for the conventional copper pipe are as shown in Table 9.

TABLE 9

| | | Comparative | Embodiment |
|---|---|---|---|
| | | example (air- | (substitute |
| Physical | | conditioner | pipe of present |
| properties | Unit | copper pipe) | invention) |
| Durability | — | Corrosion | Excellent |
| | | | corrosion- |
| | | | resistance |
| Weatherability | — | Normal | Excellent |
| Pressure of | Inner Dia. (15 | Excellent | 120 |
| breaking point | mm) kg/mm² | | |
| Minimum | Inner Dia. 15 | Excellent | 100 |
| bending radius | mm | | |
| Heat transfer | Kcal/mhr ° C. | 332 | 0.37 |
| rate | | | |
| Variation of | — | Rust and scale | No obstruction of |
| flow | | | flow And No scale |

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A composite pipe for replacing carbon steel pipes for ordinary piping and pressure service or air-conditioner copper pipes, comprising:
a first resin layer (1) positioned at the innermost portion of the pipe and formed by cross-linking a resin and giving a polar group thereto;
a first bonding layer (2) positioned between the first resin layer (1) and a metal layer (3) and bonding the first resin layer (1) and the metal layer (3) by commonly having a radical group of the first resin layer (1) and that of the metal layer (3);
the metal layer (3) positioned between the first bonding layer (2) and a second bonding layer (4) and bonding the first and second bonding layers (2 and 4) by sharing a metal radical;
the second bonding layer (4) positioned between the metal layer (3) and a second resin layer (5) and bonding the metal layer (3) and the second resin layer (5) by sharing radical groups of the metal layer (3) and the second resin layer (5); and
the second resin layer (5) positioned at the outermost portion of the pipe and formed by cross-linking a resin and giving a polar group thereto, thereby integrating the layers chemically and physically.

2. The composite pipe according to claim 1, wherein the resin of the first resin layer (1) comprises two or more selected from the group consisting of styrene isoprene styrene (SIS) resin, styrene butadiene styrene (SBS) resin, styrene ethylene butyl styrene (SEBS) resin, styrene ethylene propylene styrene (SEPS) resin, an alpha methyl styrene, vinyl toluene, 4-chloro styrene, 3,4-dichloro styrene, polyethylene, polypropylene, polybutene, polymethypentene, EPDM ternary polymer, ethylene/propylene copolymer, ethylene/butane copolymer, ethylene/vinyl acetate copolymer, ethylene/ethyl acrylate copolymer, and olefin rubber.

3. The composite pipe according to claim 1, wherein the first bonding layer (2) or the second bonding layer (4) are formed by grafting metal and organic ions in an amorphous state.

4. The composite pipe according to claim 1, wherein the first bonding layer (2) or the second bonding layer (4) are acid-treated to maximize surface bonding with the first resin layer (1) and the metal layer (3), and their radical groups are coated in such a way that the radical groups can be activated when the pipe is manufactured.

5. The composite pipe according to claim 1, wherein the metal layer (3) is formed as a metal plate film made of one selected from the group consisting of Fe, Al, Cu, Mg, Zn, and Ti.

6. A method for manufacturing a composite pipe for replacing carbon steel pipes for ordinary piping and pressure service or air-conditioner copper pipes, comprising:
inputting a resin into a hopper (21) of a main extruding machine (20), and maintaining a dry state at 60˜70° C. for two to three hours;
moving the resin inputted through the hopper (21) in a cylinder (211), of which a portion at which the resin is inputted is maintained at 150˜160° C. and a portion from which the resin is to be extruded by a nozzle (213) is maintained at 210˜220° C., wherein a temperature of the cylinder (211) is changing such that it goes up gradually by sections, and the resin is continuously moving toward the nozzle (213) according to rotation of a screw (212) mounted within the cylinder; and
extruding the resin through the nozzle and moving the resin to an inner aperture mold to form a first resin layer (1), sequentially and annularly joining a first bonding layer (2), a metal layer (3), a second bonding layer (4) extruded through a second bonding layer extruding machine (50), and a second resin layer (5) extruded through a second resin layer extruding machine (60) to the first resin layer (1) to extrude the composite pipe for replacing carbon steel pipes, processing the composite pipe in a cooling tub (70), and then winding the composite pipe to manufacture the composite pipe.
